(19) United States
(12) Patent Application Publication
(10) Pub. No.: US 2025/0305712 A1
(43) Pub. Date: Oct. 2, 2025

(54) STORM-RESISTANT LOUVER SYSTEM

(71) Applicant: EMEH, INC., Lebanon, NJ (US)

(72) Inventors: Jeffrey BLAKE, Hampton, NJ (US); Russell GEIST, Washington, NJ (US)

(73) Assignee: EMEH, INC., Lebanon, NJ (US)

(21) Appl. No.: 18/864,846

(22) PCT Filed: May 8, 2023
(86) PCT No.: PCT/US2023/021318

§ 371 Date: Nov. 11, 2024

Related U.S. Application Data
(60) Provisional application No. 63/341,082, filed on May 12, 2022.

(51) Int. Cl. F24F 13/08

(52) U.S. Cl. CPC F24F 13/082; F24F 2221/52

(57) ABSTRACT

Drainage systems and louver units are disclosed comprising a drainage apparatus. The drainage apparatus has a sill having a front sill member, a sloped sill member, and a back sill member, wherein the front sill member is coupled to the sloped sill member and the sloped sill member is coupled to the back sill member. The drainage apparatus further has a baffle coupled to the sloped sill member and configured to provide a low-pressure region. The drainage apparatus further has a sill pan comprising a base member and a back pan member, wherein the sill pan houses the sill therein and a height of the back pan member is greater than a height of the back sill member, wherein the drainage apparatus is configured to drain 8.8 inches of fluid per hour and configured to permit up to 1% of a volume of the fluid application to pass through the louver unit.

### CROSS REFERENCE TO RELATED APPLICATIONS

The present application claims priority to U.S. Patent Application Ser. No. 63/341,082, filed on May 12, 2022, the contents of which is incorporated by reference in its entirety, and to which priority is claimed.

### FIELD

The disclosed subject matter relates to a storm-resistant system and apparatus.

### BACKGROUND

Generally, systems and apparatuses exist for allowing airflow into and out of an enclosure. For example, a louver unit can be installed on a building to provide airflow for uses in heating, ventilation, and air conditioning of an interior, enclosed space within the building. One of the many problems associated with some typical, conventional louver units is the restriction of rain from entering the building through the louver unit.

To overcome at least certain problems in this field, louver units have been designed to include additional components, such as a louver/damper system or a perforated sheet/louver system. The louver/damper systems are not optimal as they must remain closed to prevent rain from passing through during extreme weather events, which prevents the louver component from performing the function of providing airflow. While the perforated sheet can prevent a significant amount of rain from entering the louver unit of a perforated sheet/louver system, these systems can still receive a large enough volume of fluid during extreme weather events to induce damage.

Thus, there remains a continued need for an improved louver system and apparatus. The presently disclosed subject matter satisfies these and other needs.

### SUMMARY

The purpose and advantages of the disclosed subject matter will be set forth in and are apparent from the description that follows, as well as will be learned by practice of the disclosed subject matter. Additional advantages of the disclosed subject matter will be realized and attained by the devices particularly pointed out in the written description and claims hereof, as well as from the appended drawings.

To achieve these and other advantages and in accordance with the purpose of the disclosed subject matter, as embodied and broadly described, the disclosed subject matter includes a drainage apparatus. The drainage apparatus comprises a sill having a front sill member, a sloped sill member, and a back sill member, wherein the front sill member is coupled to the sloped sill member and the sloped sill member is coupled to the back sill member; a baffle coupled to the sloped sill member and configured to provide a low-pressure region of the drainage apparatus; and a sill pan comprising a base member and a back pan member, wherein the sill pan houses the sill therein and a height of the back pan member is greater than a height of the back sill member, wherein the sloped sill member is disposed at an angle with respect to the base member of the sill pan, wherein the drainage apparatus is configured to drain 8.8 inches of fluid per hour and configured to permit up to 1% of a volume of the fluid application to pass through the louver unit.

In accordance with another aspect of the disclosed subject matter, a louver unit is provided. The louver unit includes a plurality of blades disposed within a frame; a perforated sheet disposed at a front side of the frame; and a drainage apparatus disposed along a bottom of the frame, wherein the drainage apparatus comprises: a sill having a front sill member, a sloped sill member, and a back sill member, wherein the front sill member is coupled to the sloped sill member and the sloped sill member is coupled to the back sill member; a baffle coupled to the sloped sill member and configured to provide a low-pressure region of the drainage apparatus; and a sill pan comprising a base member and a back pan member, wherein the sill pan houses the sill therein and a height of the back pan member is greater than a height of the back sill member, wherein the sloped sill member is disposed at an angle with respect to the base member of the sill pan, wherein the drainage apparatus is configured to drain 8.8 inches of fluid per hour and configured to permit up to 1% of a volume of the fluid application to pass through the louver unit.

In accordance with yet another aspect of the disclosed subject matter, a drainage system is provided, comprising a sill having a front sill member, a sloped sill member, and a back sill member, wherein the front sill member is coupled to the sloped sill member and the sloped sill member is coupled to the back sill member; a baffle coupled to the sloped sill member and configured to provide a low-pressure region of the drainage system; and a sill pan comprising a base member and a back pan member, wherein the sill pan houses the sill therein and a height of the back pan member is greater than a height of the back sill member, wherein the sloped sill member is disposed at an angle with respect to the base member of the sill pan, wherein the angle is selected from a range of about 10 degrees to about 20 degrees.

It is to be understood that both the foregoing general description and the following detailed description and drawings are examples and are provided for purpose of illustration and not intended to limit the scope of the disclosed subject matter in any manner.

The accompanying drawings, which are incorporated in and constitute part of this specification, are included to illustrate and provide a further understanding of the devices of the disclosed subject matter. Together with the description, the drawings serve to explain the principles of the disclosed subject matter.

### BRIEF DESCRIPTION OF THE DRAWINGS

The subject matter of the application will be more readily understood from the following detailed description when read in conjunction with the accompanying drawings, in which:

FIG. 1 is a perspective view of a drainage system, according to the disclosed subject matter.

FIG. 2A is a top, plan view of the drainage system of FIG. 1, according to the disclosed subject matter.

FIG. 2B is a top, plan view of a drainage system, according to another embodiment of the disclosed subject matter.

FIG. 2C is a detailed view of FIG. 2B.

FIG. 3 is an exploded, perspective view of the drainage system of FIG. 1, according to the disclosed subject matter.

FIG. 4 is a perspective view of a drainage apparatus of the drainage system of FIG. 1, according to the disclosed subject matter.

FIG. 5 is an internal cross-sectional view of the drainage system of FIG. 1, according to the disclosed subject matter.

### DETAILED DESCRIPTION

Reference will now be made in detail to embodiments of the disclosed subject matter, an example of which is illustrated in the accompanying drawings. The disclosed subject matter will be described in conjunction with the detailed description of the system.

In accordance with the disclosed subject matter, a drainage apparatus is provided. The drainage apparatus comprises a sill having a front sill member, a sloped sill member, and a back sill member, wherein the front sill member is coupled to the sloped sill member and the sloped sill member is coupled to the back sill member; a baffle coupled to the sloped sill member and configured to provide a low-pressure region of the drainage apparatus; and a sill pan comprising a base member and a back pan member, wherein the sill pan houses the sill therein and a height of the back pan member is greater than a height of the back sill member, wherein the sloped sill member is disposed at an angle with respect to the base member of the sill pan, wherein the drainage apparatus is configured to drain 8.8 inches of fluid per hour and configured to permit up to 1% of a volume of the fluid application to pass through the louver unit.

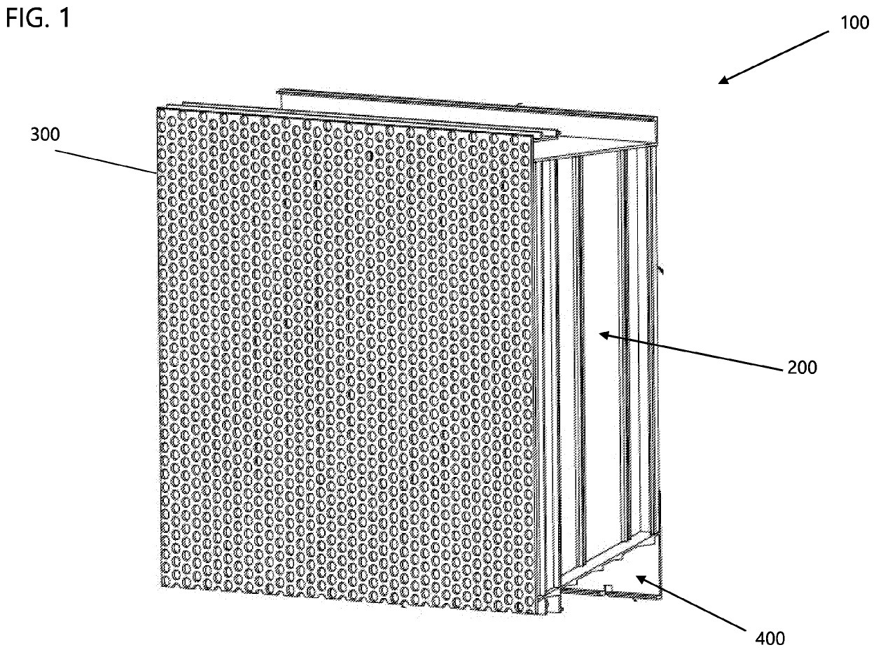

Solely for purpose of illustration, an embodiment of a drainage system 100 is shown in FIG. 1. The examples herein are not intended to limit the scope of the disclosed subject matter in any manner. The drainage system 100 may be configured to provide an airflow therethrough, inhibit at least a portion of a fluid (for example, rain, precipitation, and the like) from passing through, and discharge fluid collected by the system. As disclosed, the drainage system 100 presented herein is configured for passing an Air Movement and Control Association (AMCA) 550 standard. In accordance with the AMCA 550 standard, the drainage system 100 may be configured to receive an application of fluid simulating about 8.8 inches of rainfall per hour and allows a maximum of 1% of the volume of fluid sprayed to pass through the louver, rejecting the other 99% of the fluid volume. In embodiments, in reference to the drainage system 100 receiving an application of fluid, the fluid may be sprayed or discharged in a direction towards the drainage system 100. The drainage system 100 may discharge or direct any amount of fluid that infiltrates through the drainage system 100 out and away from the drainage system 100. In one or more embodiments, the AMCA 550 standard provides test procedures for minimum performance ratings of a louver unit of the drainage system during high velocity weather events, such as rainstorms or hurricanes.

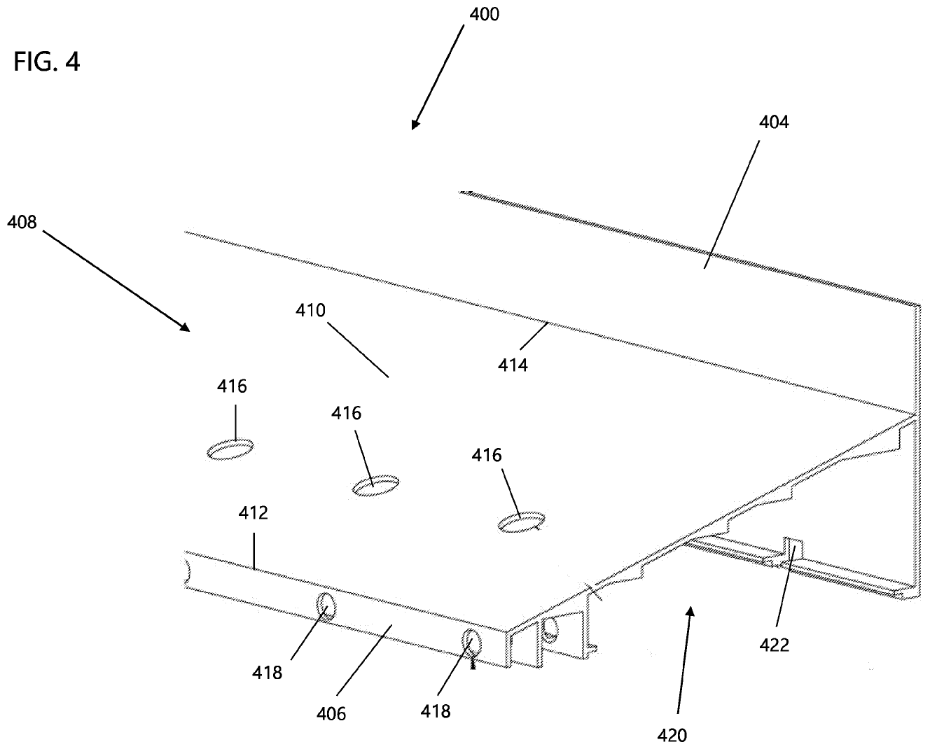

As shown in FIG. 1, the drainage system 100 may comprise a louver unit 200, a perforated sheet 300, and a drainage apparatus 400. The louver unit 200 may be configured to provide an airflow through the drainage system 100. For example, the drainage system 100 may be integral or incorporated into a building or an enclosure. The louver unit 200 may provide fluid communication between an external environment and an interior of that building or enclosure. As illustrated, the perforated sheet 300 may be coupled to a front side of the louver unit 200. The perforated sheet 300 may inhibit at least a portion of a fluid (for example, rain) from entering the louver unit 200. The louver unit 200 may be configured to prevent a remaining portion of the fluid from passing completely through the louver unit 200. The prevented fluid may be collected by the drainage apparatus 400 disposed along a bottom portion of the louver unit 200. The drainage apparatus 400 may be configured to direct the collected fluid out and away from the drainage system 100, as shown in FIG. 4 and further discussed herein.

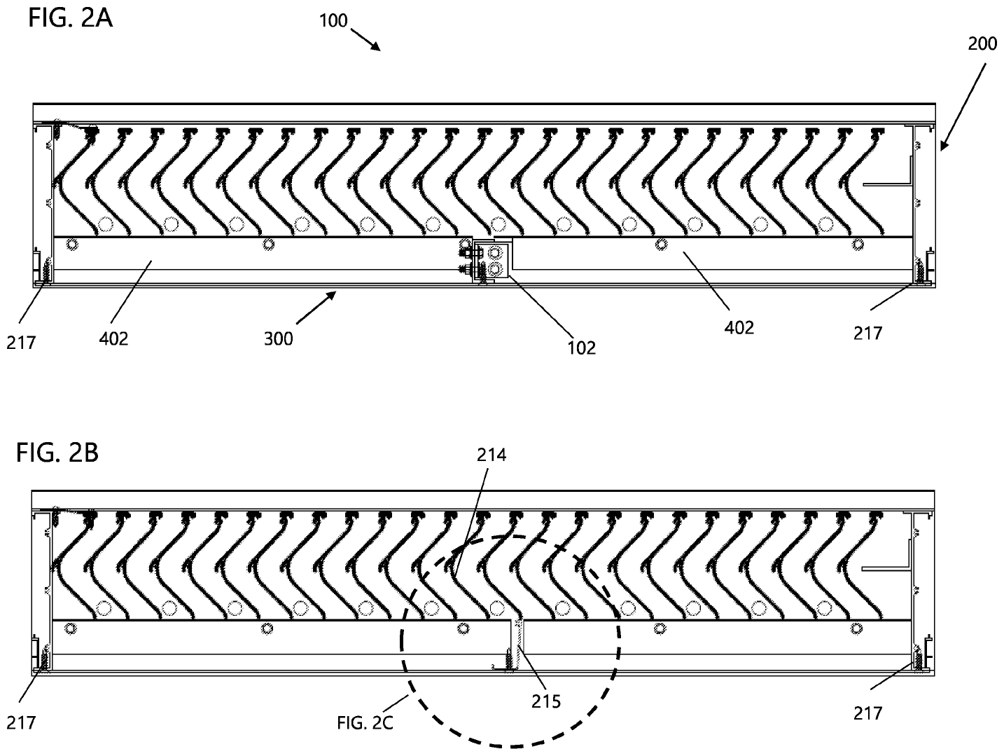

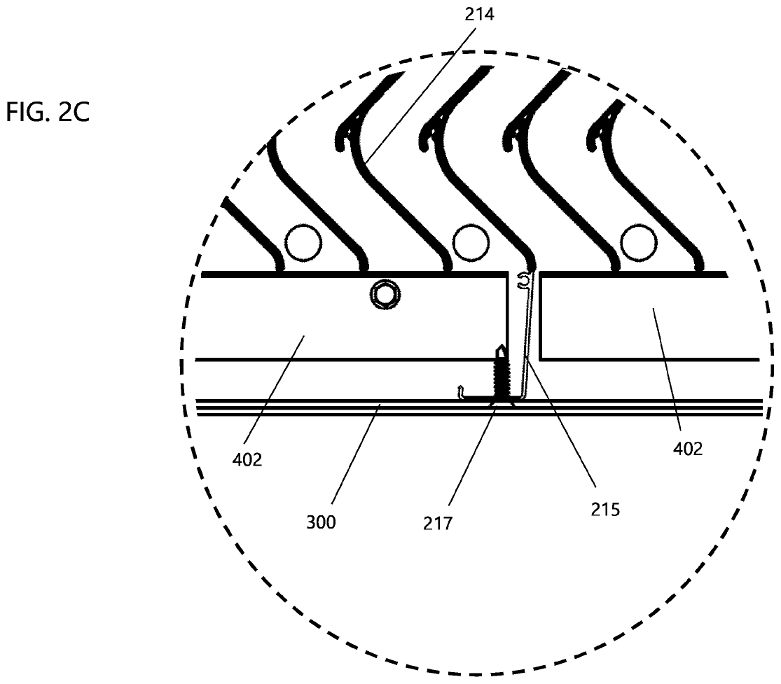

FIG. 2A depicts a top, plan view of the drainage system 100 of FIG. 1. The drainage system 100 includes the louver unit 200 coupled with the perforated sheet 300 by a support system. The support system can be configured to couple the perforated sheet 300 to the louver unit 200. The support system can include a support channel, a blade extrusion, or other suitable support mechanisms. As illustrated in the embodiment of FIG. 2A, the support system includes a sheet support channel 102 disposed about a central location along a width of the louver unit 200 and perforated sheet 300, but the subject matter presently described is not limited to such location. The sheet support channel 102 may be disposed about any suitable location between the louver unit 200 and perforated sheet 300. In other embodiments, there may be a plurality of sheet support channels 102. The sheet support channel 102 may couple the perforated sheet 300 to the louver unit 200 through any suitable means, including through the use of fasteners, screws, adhesives, brazing, welding, and the like. The sheet support channel 102 may be any suitable size, height, and/or shape. In embodiments, the sheet support channel 102 may comprise approximately the same height as the louver unit 200. In additional embodiments, the support system can include a blade extrusion or a blade attachment that couples the louver unit 200 with the perforated sheet 300 as shown in FIG. 2B and FIG. 2C and further discussed below.

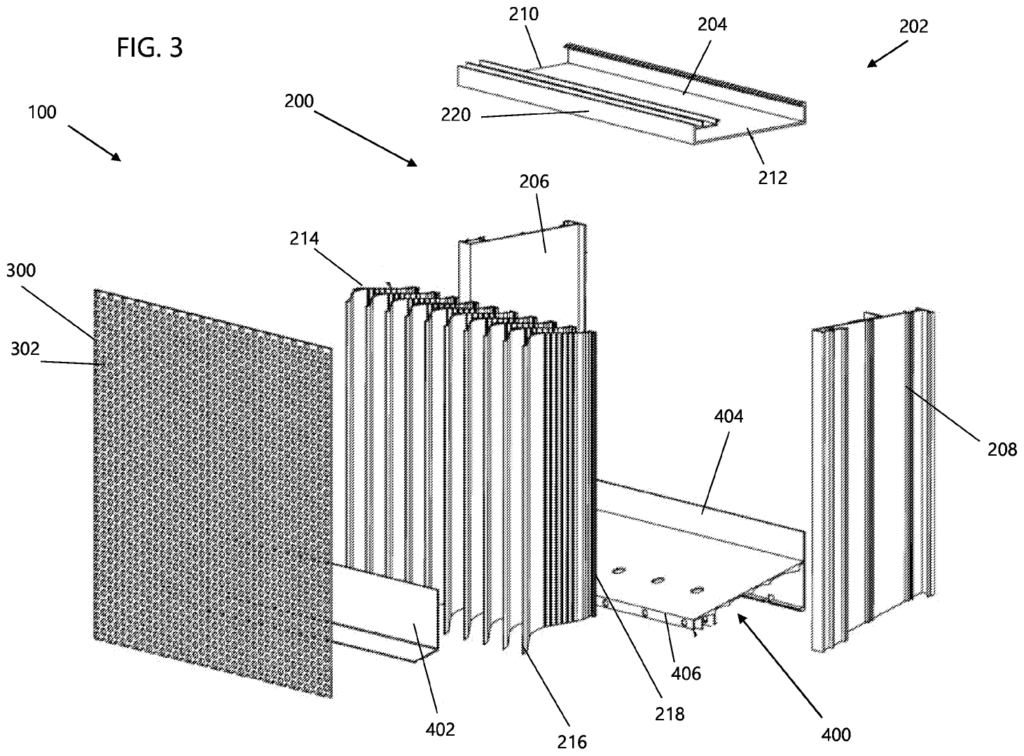

FIG. 3 depicts an exploded, perspective view of the drainage system 100 of FIG. 1. The drainage system 100 further includes a frame 202 defining the louver unit 200. The support system is not shown, but any embodiment can be used with said drainage system as previously described. The frame 202 can have any suitable size and shape. In accordance with these embodiments, the frame 202 can be made out of a plurality of suitable materials. For instance, the frame 202 can be made out of metals, nonmetals, polymers, composites, ceramics, and any combination thereof. As illustrated, the frame 202 has a top 204, a first side 206, and a second side 208. A first end 210 of the top 204 may be coupled to the first side 206, and a second end 212 of the top 204 may be coupled to the second side 208. As shown, the first side 206 may be disposed opposite to the second side 208 in relation to the top 204.

The louver unit 200 further has a plurality of blades 214 disposed within the frame 202. The plurality of blades 214 may be configured to inhibit a fluid from continuing to flow through the louver unit 200. Each one of the plurality of blades 214 can have any suitable size and shape. In embodiments, each of the plurality of blades 214 has the same approximate shape and dimensions. Further, there may be any suitable number of the plurality of blades 214 in the louver unit 200. In accordance with these embodiments, the plurality of blades 214 can be made out of a plurality of suitable materials. For instance, each one of the plurality of blades 214 can be made out of metals, nonmetals, polymers, composites, ceramics, and any combination thereof. In embodiments, each there may be a suitable distance between each set of adjacent blades 214. Without limitations, the suitable distance may be selected from a range of about 0.5 inches to about 4 inches.

As shown in FIG. 2B, a blade attachment 215 is coupled to the perforated sheet 300, such as by a screw 217 for purposes of example and not limitation. FIG. 2C is a detailed view of the plan view of FIG. 2B about the dashed line, which depicts the support system embodied as the blade attachment. As depicted in FIG. 2C, a proximal end of the blade attachment 215 has a “J” configuration in plan view, but any suitable configuration is contemplated herein. The blade attachment can be a monolithic and integral blade disposed at any suitable location adjacent blades 214. In this regard, there can be a single blade attachment 215 along the frame 202 or there can be a plurality of blade attachments 215 proximate the blades 214. The blade attachment(s) 215 can be constructed of the same material or can be constructed of different material as the blades 214. Each of the blades 214 and the blade attachment 215 can be coupled with the frame 202 and the drainage apparatus 400 by secure connection, such as for purposes of example by screw.

As illustrated throughout the figures, the drainage apparatus 400 may be disposed between the first side 206 and the second side 208 at ends thereof opposite from the top 204 of the louver unit. The plurality of blades 214 may be disposed on top of the drainage apparatus 400, thereby contained between the frame 204 and the drainage apparatus 400. A baffle 402 of the drainage apparatus 400 may be disposed along a first end 216 of each one of the plurality of blades 214. The baffle 402 may extend at least partially upwards parallel to a length of the plurality of blades 214 to provide a low-pressure region along the drainage apparatus 400. A second end 218 of each one of the plurality of blades 214 may be disposed along a back sill member 404 of the drainage apparatus 400.

In accordance with the embodiments of the subject matter previously described, the sheet support channel 102 (referring to FIG. 2A) may extend from the drainage apparatus 400 towards the top 204 of the frame 202. The sheet support channel 102 may be located between multiple baffles 402 or may be disposed through a singular baffle 402 extending throughout the width of the drainage apparatus 400. In the embodiment of FIG. 2B and FIG. 2C, a first and second baffle 402 are spaced apart to enable the blade attachment 215 to extend between the baffles 402 to couple the louver unit 200 with the perforated sheet 300.

In embodiments, the perforated sheet 300 may be coupled to the louver unit 200 via the sheet support channel 102. The perforated sheet 300 may be disposed against or in-line with a front side 220 of the frame 202, wherein the front side 220 is open to an external environment. The opposing side of the frame 202 may be accessible to an interior of a building or enclosure. The perforated sheet 300 may further be disposed to abut a front sill member 406 of the drainage apparatus 400 without the need for sealant or caulk along the connection. The perforated sheet 300 may be configured to inhibit at least a portion of a fluid (for example, rain) from entering the louver unit 200 while maintaining a flow path for an airflow. As illustrated, there may be a plurality of perforations 302 defined in the perforated sheet 300. In embodiments, a volume of fluid may enter into the louver unit 200 through the plurality of perforations 302. The plurality of perforations 302 may be uniformly distributed throughout the perforated sheet 300 or distributed in a suitable pattern. The perforated sheet 300 can have any suitable size and shape. In embodiments, the perforated sheet 300 may be approximately the same size and shape as the frame 202. The perforated sheet 300 can be made out of a plurality of suitable materials. For instance, the perforated sheet 300 can be made out of metals, nonmetals, polymers, composites, ceramics, and any combination thereof.

FIG. 4 depicts a perspective view of the drainage apparatus 400. The drainage apparatus 400 is configured to direct a flow of fluid out through the front side 220 (referring to FIG. 3) of the frame 202 (referring to FIG. 3). The drainage apparatus 400 can have any suitable size and shape. In accordance with these embodiments, the drainage apparatus 400 can be made out of a plurality of suitable materials. The drainage apparatus 400 includes a sill 408 having the front sill member 406, a sloped sill member 410, and the back sill member 404. A first end 412 of the sloped sill member 410 may be coupled to the front sill member 406, and a second end 414 of the sloped sill member 410 may be coupled to the back sill member 404. Both the front sill member 406 and the back sill member 404 may be disposed parallel to each other and extend in a vertical direction away from the sloped sill member 410. The sloped sill member 410 may define a first set of holes 416 therein, wherein the first set of holes 416 is located along the sloped sill member 410 between the baffle 402 (referring to FIG. 3) and the back sill member 404. The front sill member 406 may define a second set of holes 418 therein configured to discharge a fluid received by the drainage apparatus 400. Each one of the first set of holes 416 and second set of holes 418 can have any suitable size and shape.

In embodiments, a fluid may be received by the drainage apparatus 400, wherein the fluid may settle on the sloped sill member 410. Due to gravity and an angle of the sloped sill member 410, the fluid may be directed into the first set of holes 416. Without limitations, the angle of the sloped sill member 410 may be selected from a range of about 5 degrees to about 30 degrees. In one or more embodiments, the angle may be about 10 degrees to about 20 degrees. The fluid may be introduced into an internal chamber 420 disposed underneath the sloped sill member 410 and may be directed to exit through the second set of holes 418.

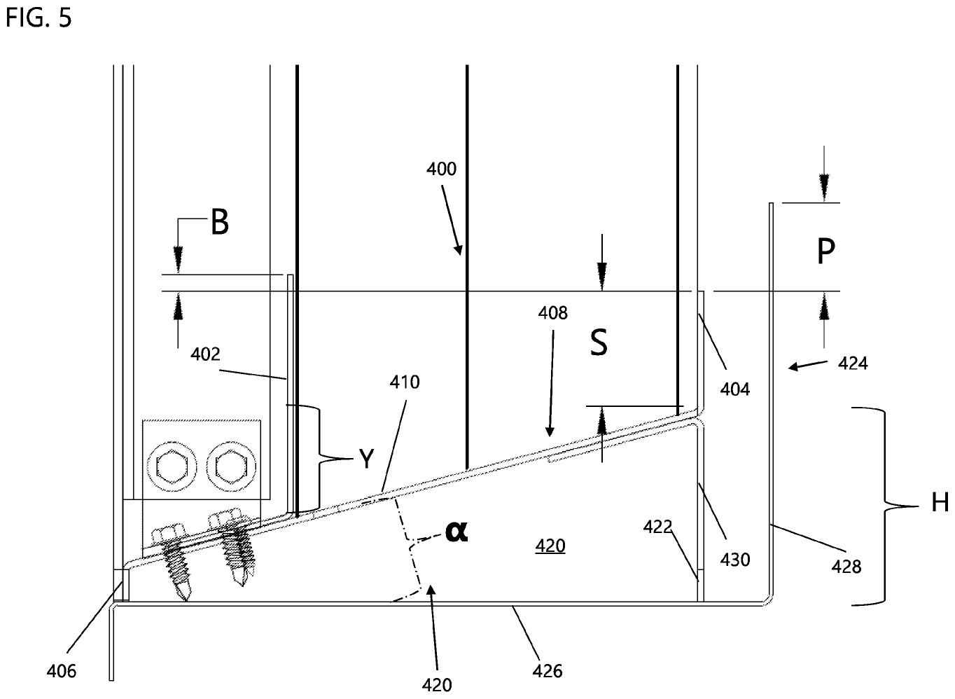

As illustrated, the back sill member 404 may extend vertically in two directions from the second end 414 of the sloped sill member 410. In other embodiments, the back sill member 404 may solely extend upwards, and a support member (as seen in FIG. 5) may be coupled to the sloped sill member 410 and extend downwards to support the sloped sill member 410 at the angle. In this embodiment, the back sill member 404 may comprise a plurality of notches 422 defined therein configured to direct fluid received by a sill pan (as seen in FIG. 5) into the internal chamber 420. In other embodiments, the plurality of notches 422 may be defined in the support member. The plurality of notches 422 can have any suitable size and shape. The plurality of notches 422 may be staggered in relation to the second set of holes 418. The sill can be comprised of a monolithic, integral unit as shown in FIG. 4 or can be constructed of a number of component parts welded together as provided by FIG. 5 discussed below.

FIG. 5 depicts an internal cross-sectional view of the drainage apparatus 400. As illustrated, the drainage apparatus 400 further includes a sill pan 424 comprising a base member 426 and a back pan member 428. The sill pan 424 is configured to house the sill 408 therein. In embodiments, a height of the back pan member 428 (H+S+P) is greater than a height(S) of the back sill member 404, and the sloped sill member 410 is disposed at an angle alpha α with respect to the base member 426 of the sill pan 424. As noted herein, the angle alpha α can range from about 10 degrees to about 20 degrees and is shown as 15 degrees in FIG. 5 by way of example. In accordance with the embodiments of the subject matter previously described, the sill 408 further includes the support member 430 that supports the sloped sill member 410 at the angle relative to the base member 426 of the sill pan 424. The support member 430 can be monolithic and integral with the sloped sill member 410. In this embodiment, the plurality of notches 422 are defined in the support member 430, and the internal chamber 420 is defined by the front sill member 406 (referring to FIG. 4), the sloped sill member 410, the support member 430, and the base member 426. As illustrated, the baffle 402 extends away from the sloped sill member 410 and away from the sill pan 424, wherein a height of the baffle 402 (Y+S+B) is greater than the height(S) of the back sill member 404 and less than the height of the back pan member 428. For example, the supplemental height B of the baffle 402 above the back sill member 404 may be about 15-18% greater than the height S of the back sill member 404 (without accounting for Y), such as for purposes of example B can be about 0.25 inches (16.6% greater than S) when S has a height of approximately 1.5 inches. Further, the supplemental height P of the back pan member 428 can be about 73-78% greater than the height S of the back sill member 404 (without accounting for H), such as for purposes of example P can be about 1.125 inches (75% greater than S) and S can be about 1.5 inches.

While the disclosed subject matter is described herein in terms of certain embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the various embodiments depicted and claimed, the disclosed subject matter is also directed to other embodiments having any other possible combination of the features disclosed and claimed herein. As such, the particular features presented herein can be combined with each other in other manners within the scope of the disclosed subject matter such that the disclosed subject matter includes any suitable combination of the features disclosed herein. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the system and unit of the disclosed subject matter without departing from the spirit or scope of the disclosed subject matter. Thus, it is intended that the disclosed subject matter include modifications and variations that are within the scope of the appended claims and their equivalents.

What is claimed is:

1. A drainage apparatus, comprising:
a sill having a front sill member, a sloped sill member, and a back sill member, wherein the front sill member is coupled to the sloped sill member and the sloped sill member is coupled to the back sill member;
a baffle coupled to the sloped sill member and configured to provide a low-pressure region of the drainage apparatus; and
a sill pan comprising a base member and a back pan member, wherein the sill pan houses the sill therein and a height of the back pan member is greater than a height of the back sill member, wherein the sloped sill member is disposed at an angle with respect to the base member of the sill pan, wherein a louver unit coupled to the drainage apparatus is configured to receive an application of fluid simulating at least about 8.8 inches of rainfall per hour and the drainage apparatus is configured to permit up to 1% of a volume of the fluid application to pass through the louver unit.

2. The drainage apparatus of claim 1, wherein the angle is selected from a range of about 10 degrees to about 20 degrees.

3. The drainage apparatus of claim 1, wherein the sloped sill member defines a first set of holes therein, wherein the first set of holes is located along the sloped sill member between the baffle and the back sill member of the sill pan.

4. The drainage apparatus of claim 3, wherein the front sill member defines a second set of holes configured to discharge fluid received by the drainage apparatus.

5. The drainage apparatus of claim 1, wherein the sill further comprises a support member to support the sloped sill member at the angle relative to the base member of the sill pan.

6. The drainage apparatus of claim 5, wherein the support member comprises a plurality of notches configured to direct fluid received by the sill pan into an internal chamber defined by the front sill member, the sloped sill member, the support member, and the base member of the sill pan.

7. The drainage apparatus of claim 6, wherein the front sill member defines a set of holes staggered in relation to the plurality of notches of the support member, wherein the set of holes of the front sill member is configured to discharge fluid out from the internal chamber away from the back pan member.

8. The drainage apparatus of claim 1, wherein the baffle extends away from the sloped sill member and away from the sill pan, wherein a height of the baffle is greater than the height of the back sill member and less than the height of the back pan member.

9. The drainage apparatus of claim 1, wherein the drainage apparatus has a pass rating according to Air Movement and Control Association (AMCA) 550 standard.

10. A louver unit, comprising:
a plurality of blades disposed within a frame;
a perforated sheet disposed at a front side of the frame; and
a drainage apparatus disposed along a bottom of the frame, wherein the drainage apparatus comprises:
a sill having a front sill member, a sloped sill member, and a back sill member, wherein the front sill member is coupled to the sloped sill member and the sloped sill member is coupled to the back sill member;
a baffle coupled to the sloped sill member and configured to provide a low-pressure region of the drainage apparatus; and
a sill pan comprising a base member and a back pan member, wherein the sill pan houses the sill therein and a height of the back pan member is greater than a height of the back sill member, wherein the sloped sill member is disposed at an angle with respect to the base member of the sill pan, wherein the louver unit is configured to receive an application of fluid simulating at least about 8.8 inches of rainfall per hour and permits up to 1% of a volume of the fluid application to pass through the louver unit.

11. The louver unit of claim 10, wherein the drainage apparatus has a pass rating according to Air Movement and Control Association (AMCA) 550 standard.

12. The louver unit of claim 10, further comprising a support system disposed at the front side of the frame configured to couple the perforated sheet to the frame.

13. The louver unit of claim 10, wherein the angle is selected from a range of about 10 degrees to about 20 degrees.

14. The louver unit of claim 10, wherein the sloped sill member defines a first set of holes therein, wherein the first set of holes is located along the sloped sill member between the baffle and the back sill member of the sill pan.

15. The louver unit of claim 14, wherein each one of the first set of holes is disposed between adjacent sets of the plurality of blades, wherein there is a space between each one of the plurality of blades and the baffle providing fluid communication between the plurality of blades.

16. The louver unit of claim 14, wherein the front sill member defines a second set of holes configured to discharge fluid received by the drainage apparatus.

17. The louver unit of claim 10, wherein the sill further comprises a support member to support the sloped sill member at the angle relative to the base member of the sill pan, wherein the support member comprises a plurality of notches configured to direct fluid received by the sill pan into an internal chamber defined by the front sill member, the sloped sill member, the support member, and the base member of the sill pan.

18. The louver unit of claim 17, wherein the front sill member defines a set of holes staggered in relation to the plurality of notches of the support member, wherein the set of holes of the front sill member is configured to discharge fluid out from the internal chamber away from the back pan member.

19. The louver unit of claim 10, wherein the baffle extends away from the sloped sill member and away from the sill pan, wherein a height of the baffle is greater than the height of the back sill member and less than the height of the back pan member.

20. A drainage system, comprising:
a sill having a front sill member, a sloped sill member, and a back sill member, wherein the front sill member is coupled to the sloped sill member and the sloped sill member is coupled to the back sill member;
a baffle coupled to the sloped sill member and configured to provide a low-pressure region of the drainage system; and
a sill pan comprising a base member and a back pan member, wherein the sill pan houses the sill therein and a height of the back pan member is greater than a height of the back sill member, wherein the sloped sill member is disposed at an angle with respect to the base member of the sill pan, wherein the angle is selected from a range of about 10 degrees to about 20 degrees.
